(19) United States
(12) Patent Application Publication
(10) Pub. No.: US 2026/0005888 A1
(43) Pub. Date: Jan. 1, 2026

(54) HEADSET APPLICATION

(71) Applicant: TenFour Labs, Inc., Lincoln, NE (US)

(72) Inventors: Charles N. Hawk, Lincoln, NE (US); Mason L. Foxvog, Lincoln, NE (US); Patrick Daberkow, Seward, NE (US); Jesse L. Burbach, Lincoln, NE (US); Nicholas R. Topp, Lincoln, NE (US); Dayton Daberkow, Wahoo, NE (US)

(21) Appl. No.: 19/255,619

(22) Filed: Jun. 30, 2025

Related U.S. Application Data
(60) Provisional application No. 63/665,976, filed on Jun. 28, 2024.

(51) Int. Cl. H04L 12/18; H04L 5/14; H04L 65/1094; H04M 7/00

(52) U.S. Cl. CPC H04L 12/1822; H04L 5/14; H04L 65/1094; H04M 7/006

(57) ABSTRACT

A system for providing audio communication may include a host device. The host device may include a non-transitory medium with stored instructions that cause a host device to access a server providing voice over internet protocol (VoIP) service, initiate a duplex communication session via the VoIP service, wherein the duplex communication session is performed via a single voice connection, transmit a session invitation to a plurality of edge devices, transmit a voice communication between the host device and the first group of edge devices via the first virtual channel; and, upon a first input event from the host device, simultaneously switch the voice communication from transmitting between the host device and the first group of edge devices to transmitting between the host device and both the first group of edge devices and the second group of edge devices via the respective first virtual channel and a second virtual channel.

The present application claims the benefit under 35 U.S.C. § 119(e) of U.S. Provisional Application Ser. No. 63/665,976, filed Jun. 28, 2024, which is incorporated herein by reference in the entirety.

### TECHNICAL FIELD

The present invention generally relates to communication systems, and in particular to communication systems between sports team members.

### BACKGROUND

Communication systems for sports teams such as baseball and American football typically include radio headsets that permit head coaches to communicate with other coaches and players. When used at sporting events and practices, the radio headsets often require the use of base towers, antennas, hip boxes, coaxial cables, and other equipment that would need to be hauled to the sporting event, and considerable time would be spent setting up the communication systems. In some cases, the communication systems would require 20 minutes or more of setup and teardown, reducing the time spent on practice or sporting event preparation.

These radio-based communication systems often use unsecured open radio frequencies, which have an increased risk of interference and/or break-ins from other radio systems. These communication systems also required a set number of users (e.g., headsets), such that adding new users would require the purchase of new hardware. The communication systems also limited the ability of a coach to communicate with multiple coaches and/or players at the same time. In particular, the communication systems did not allow a head coach to broadcast to all channels simultaneously when needed. Therefore, it would be advantageous to provide a system and method that overcomes the shortcomings described above.

### SUMMARY

In embodiments, a system for providing audio communication is disclosed. In embodiments, the system includes a host device. In embodiments, the host device includes a non-transitory medium with stored instructions that cause a host device to access a server providing voice over internet protocol (VoIP) service, initiate a duplex communication session via the VoIP service, wherein the communication session is performed via a single voice connection, transmit a session invitation to a plurality of edge devices, receive a plurality of responses from the plurality of edge devices, assign a first virtual channel within the single voice connection between a host device and a first group of edge devices of the plurality of edge devices, and assign one or more virtual channels within the single voice connection between the host device and a second group of edge devices of the plurality of edge devices. In embodiments, the instructions may cause the host device to transmit a voice communication between the host device and the first group of edge devices via the first virtual channel; and upon a first input event from the host device, simultaneously switch the voice communication from transmitting between the host device and the first group of edge devices to transmitting between the host device and both the first group of edge devices and the second group of edge devices via the respective first virtual channel and the second virtual channel.

In embodiments, a non-transitory medium with stored instructions is disclosed. In embodiments, the stored instructions cause a host device to access a server providing voice over internet protocol (VOIP) service, initiate a duplex communication session via the VoIP service, wherein the communication session is performed via a single voice connection, transmit a session invitation to a plurality of edge devices, receive a response from the plurality of edge devices, assign a first virtual channel within the single voice connection between a host device and a first group of edge devices of the plurality of edge devices, assign one or more virtual channels within the single voice connection between the host device and a second group of edge devices of the plurality of edge devices. In embodiments, the stored instructions cause a host device to transmit a voice communication between the host device and the first group of edge devices via the first virtual channel, and upon a first input event from the host device, simultaneously switch the voice communication from transmitting between the host device and the first group of edge devices to transmitting between the host device and both the first group of edge devices and the second group of edge devices via the respective first virtual channel and the second virtual channel.

In embodiments, a method for providing audio communication is disclosed. In embodiments, the method includes accessing a server providing voice over internet protocol (VoIP) service. In embodiments, the method includes initiating a duplex communication session via the VoIP service, wherein the communication session is performed via a single voice connection. In embodiments, the method includes transmitting a session invitation to a plurality of edge devices. In embodiments, the method includes receiving a response from the plurality of edge devices. In embodiments, the method includes assigning a first virtual channel within the single voice connection between a host device and a first group of edge devices of the plurality of edge devices. In embodiments, the method includes assigning one or more virtual channels within the single voice connection between the host device and a second group of edge devices of the plurality of edge devices. In embodiments, the method includes transmitting a voice communication between the host device and the first group of edge devices via the first virtual channel. In embodiments, the method includes upon a first input event from the host device, simultaneously switching the voice communication from transmitting between the host device and the first group of edge devices to transmitting between the host device and both the first group of edge devices and the second group of edge devices via the respective first virtual channel and the second virtual channel.

### BRIEF DESCRIPTION OF THE DRAWINGS

The numerous advantages of the disclosure may be better understood by those skilled in the art by reference to the accompanying figures.

FIG. 1 illustrates a block diagram view of a communication system, in accordance with one or more embodiments of the present disclosure.

FIG. 2 illustrates a block diagram view of a communication system that includes a participant edge device, in accordance with one or more embodiments of the present disclosure.

FIG. 3 illustrates a home screen of a user interface for a host device, in accordance with one or more embodiments of the disclosure.

FIG. 4 illustrates a communication screen of the user interface for a host device, in accordance with one or more embodiments of the disclosure.

FIG. 5 illustrates a pitch call screen of the user interface for a host device, in accordance with one or more embodiments of the disclosure.

FIG. 6 is an illustration of a system for providing communication between team members in an environment of a baseball event, in accordance with one or more embodiments of the disclosure.

FIG. 7 is an illustration of a system for providing communication between team members in an environment of an American football event, in accordance with one or more embodiments of the disclosure.

FIG. 8 is an illustration of a top view of a smartwatch used by the system, in accordance with one or more embodiments of the disclosure.

FIG. 9 illustrates a process flow diagram of a method depicting a method for providing audio communication, in accordance with one or more embodiments of the disclosure.

FIGS. 10A and 10B illustrate team-member screens of the user interface for a host device, in accordance with one or more embodiments of the disclosure.

FIG. 11 illustrates a host device transmitting an instruction signal to a participant edge device, in accordance with one or more embodiments of the disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

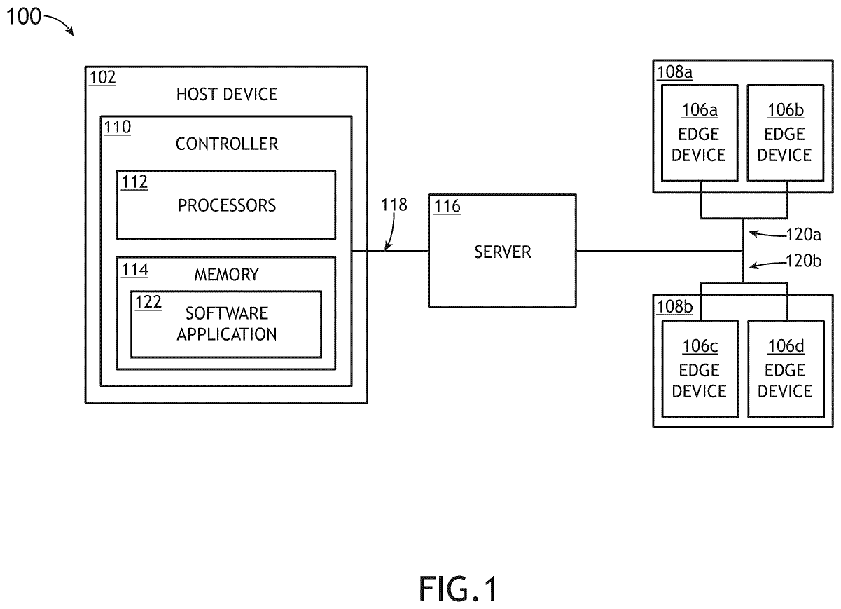

FIGS. 1-11 generally illustrate a system and method for communicating between members of a sports team, in accordance with one or more embodiments of the present disclosure. Embodiments of the present disclosure are directed to a software application used by a host device to communicate with a plurality of edge devices. Embodiments of the present disclosure are also directed to a host device configured to communicate with one or more edge devices via a voice-over internet protocol (VOIP). The system and method enable the host device to communicate via voice communication with a plurality of edge devices via a plurality of virtual channels organized within a single voice connection, allowing rapid switching between virtual channels. The system and method also enable the host device to rapidly switch from communicating via a single virtual channel to communicating with all virtual channels.

FIG. 1 illustrates a block diagram view of a communication system 100, in accordance with one or more embodiments of the present disclosure. The communication system 100 may be used to enable communication between members of a sport team. Sports teams that use the communication system 100 may include, but are not limited to, baseball teams, football teams (e.g., soccer), American football teams, softball teams, track and field teams, volleyball teams, and basketball teams).

In embodiments, the system 100 includes a host device 102, and a set or a plurality of edge devices 106a-d that are organized into groups 108a-b. The set may include any number of groups 108 of edge devices 106. For example, the set may include one group 108, two groups 108, three groups 108, four groups 108, five groups 108, six groups 108, or seven or more groups 108 of edge devices 106. The one or more groups 108 may include any number of edge devices 106. For example, the group may include one edge device 106, two edge devices 106, three edge devices 106, or four or more edge devices 106.

In embodiments, the host device 102 includes one or more controllers 110, with one or more processors 112 configured to execute program instructions maintained on a memory 114 (e.g., a non-transitory medium). For example, the memory 114 may maintain program instructions configured to cause the one or more processors 112 to carry out any of the one or more process steps described throughout the present disclosure. Each edge device 106 may also include respective controllers with respective processors and respective memory for communicating with the host device 102 and/or other edge devices 106.

The host device 102 may include any communication device that can be configured for duplex wireless communication (e.g., such as voice over internet protocol (VOIP) communication) including, but not limited to, a smartphone (e.g., cell phone or mobile phone) or smartwatch. The edge devices 106 may include any communication device that can be configured for wireless communication with the host device 102, including but not limited to, a smartphone, a smartwatch, and a speaker (e.g., such as a Bluetooth speaker).

In embodiments, the system 100 may include a server 116 that enables communication between the host device 102 and the set of edge devices 106. For example, the server 116 may provide a service, such as a VoIP service, which allows the host device 102 to communicate with the set of edge devices 106 via VoIP. The server 116 may include a cloud-based server provided by a service provider, or may include a stand-alone computer. The use of a server 116 for enabling VoIP services is well-known to the communication industry.

In embodiments, the host device 102 communicates with the set of edge devices 106 via a single voice connection 118. The single voice connection 118 is capable of supporting multiple virtual channels 120a-b that correspond to the groups 108a-b of edge devices 106a-d. Because the multiple virtual channels 120a-b are supported by the single voice connection 118, the host device 102 can quickly switch between different groups 108a-b of edge devices 108a-d.

As used herein, a “voice connection” refers to an end-to-end communication channel that permits data packet transfer between endpoints (e.g., the host device 102 and the set of edge devices 106). Once a voice connection within the VoIP server has been created, virtual channels between the endpoints can be created, allowing selective communication between the host device 102 and the set of edge devices 106.

In embodiments, the system 100 includes a software application 122 stored by the memory 114 that provides instructions to the one or more processors 112 that execute the instructions. For example, the stored instructions may cause the one or more processors 112 to access the server 116 that provides a VoIP service. In another example, the instructions may cause the one or more processors 112 to initiate a duplex communication session via the VoIP service. In embodiments, the software application instructs the processors 112 to provide a user interface (UI) that guides a user of the host device while running the software application 122.

Initiating the communication session may include setting up and/or defining the infrastructure of a room that houses the set or group 108 of edge devices 106 that are predicted to be in communication with the host device 102. For example, initiating the communication session may include creating a room template. For instance, creating a room template may include, but not be limited to, naming the communication session, creating and/or naming virtual channel and/or groups 108 within the communication session, and defining the number or maximum number of edge devices 106, and setting parameters for one or more of the edge devices 106 (e.g., whether one or more of the edge devices 106 will be muted in the communication session). In another example, initiating the communication system may include authenticating the host device 102 with the server 116.

In another example, the stored instructions may cause the one or more processors 112 to transmit a session invitation to a set of edge devices 106. For example, the instructions may cause the one or more processors 112 to send push notifications to each edge device 106 of the set of edge devices 106. The users of the edge devices 106 may then respond to the push notification, causing an edge device version of the software application 122 to load on their respective edge devices 106, along with an edge device version of the user interface.

In embodiments, the stored instructions cause the one or more processors 112 to receive a plurality of responses from the set of edge devices 106. The host device 102 may then automatically, or manually by the user of the host device 102, admit the edge devices 106 into the communication session.

In embodiments, the stored instructions cause the one or more processors 112 to assign a first virtual channel 120a between the host device 102 and edge devices 106a-b within the first group 108a of the set of edge devices 106. In embodiments, the instructions cause the one or more processors to assign a second virtual channel 120b between the host device 102 and edge devices 106b-c within the second group 108b of the set of edge devices 106. The system 100 may include as many virtual channels 120 and as many edge devices 106 as can be supported by the VoIP service.

In embodiments, the stored instructions cause the one or more processors 112 to transmit a voice communication between the host device 102 and the first group 108a of edge devices 106a-b via the first virtual channel 120a. For example, the user of the host device 102, such as a head coach of a sports team, may initiate conversations with the users of the edge devices 106a-b first virtual channel 120a (e.g., the users including a group of assistant coaches). The head coach may then select the group 108a of edge devices 106a-b corresponding to the group of assistant coaches by pressing a button on the user interface associated with the group 108a. Selecting the group 108a on the user interface causes a virtual channel 120a to open within the already-open single voice connection, allowing the coach to talk to the group of assistant coaches via the VoIP service.

In embodiments, the stored instructions cause the one or more processors 112 to, upon a first input event from the host device 102, simultaneously switch the voice communication from transmitting between the host device 102 and the first group 102a of edge devices 106a-b to transmitting between the host device 102 and both the first group 108a of edge devices 106a-b and the second group 108b of edge devices 106c-d via the respective first virtual channel 120a and the second virtual channel 120b. For example, the coach may want to address all groups 108a-b of the team (e.g., the assistant coach group and a player group). To talk to all team members simultaneously, the coach presses a button on the user interface of the host device 102 (e.g., a “call all members” button). By pressing the button, the user interface causes both the first virtual channel 120a and the second virtual channel 120b to open, allowing the coach to talk to the host device 102 and deliver voice communications to all edge devices 106a-d.

As used herein, an “input event” refers to any input from a user (e.g., touch, voice, facial expression) that can be detected by sensors within the host device 102. (e.g., sensors within touchscreens, microphones, or cameras). For example, the input event may include a tap, swipe, push, or other movement of a finger or stylus on a touchscreen of the host device 102. For instance, the first input event may include or consist of a single button input (e.g., a tap) on the touchscreen of the host device 102.

In embodiments, the stored instructions cause the one or more processors 112 to assign a communication profile to at least one edge device 106 of the first group 108a of edge devices 106 or the second group 108b of edge devices 106. For example, the coach may be able to select, via the host device, a listen-only communication profile for specific edge devices 106 or specific groups 108 of edge devices 106. For example, a coach may select, via the user interface, that the edge devices 106c-d for a group of players have a listen-only communication profile and that the edge devices 106a-b for a group of assistant coaches have a listen-and-speak communication profile. Other communication profiles may include, but are not limited to, a limitation or a privilege of a specific edge device 106 to a specific group 108, a limitation or a privilege of a specific edge device 106 to invite other edge devices 106, a limitation or a privilege of an edge device 106 to manage access or limitations/privileges to other edge devices 106.

In embodiments, the voice communications between the host device 102 and the edge devices 106 are modified via background noise suppression. For example, the software application 122, host device 102, and/or VoIP service may include background noise suppression software that can modify voice communications so that background noise in the voice communication is suppressed, or that the voice of the voice communication is isolated and/or amplified, allowing the system 100 to isolate audio inputs of a user's voice. Background suppression software is known in digital communication systems.

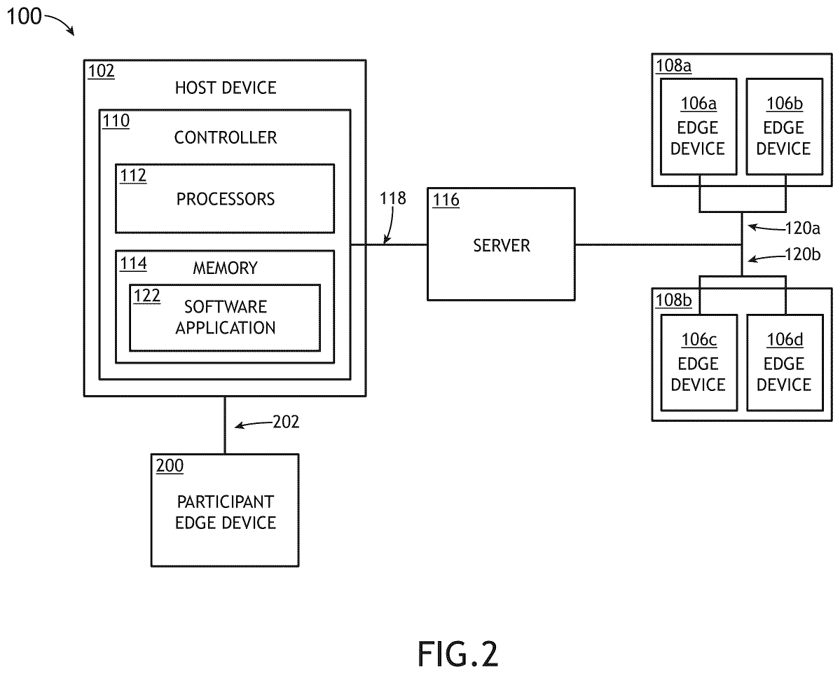

FIG. 2 illustrates a block diagram view of a communication system 100 that includes a participant edge device 200, in accordance with one or more embodiments of the present disclosure. For example, the participant edge device 200 may be used by a player on the team. For instance, the player may include a catcher on a baseball team that is receiving coaching signals, such as pitch selection signals, from the coach via the host device 102. Once received, the catcher can relay the pitch selection signals to the pitcher.

The participant edge device 200 may include a communication device similar to the edge devices 106 that permits duplex communication (e.g., a smartphone or smartwatch), or may include a communication device that enables half-duplex communication where the participant edge device 200 receives, but cannot transmit, voice or other information to the host device 102. For example, the participant may include a speaker (e.g., headphone, earbud, or earphone) or smartphone and smart watches that are set for half-duplex communication. By limiting the participant edge device 200 to half-duplex communication, the participant edge device 200 may comply with various sports authorities that allow one-way, but not two-way, electronic communication between a coach and a catcher, or other player, during an active sporting event.

In embodiments, the coaching signal is transmitted wirelessly to the participant edge device 200. For example, the coaching signal may be sent via a short-range radio communication 202. Short-range communication technologies used to communicate between the host device 102 and the participant edge device 200 include, but are not limited to, Bluetooth technology, Zigbee technology, Z-Wave technology, IrDA technology, Wi-Fi technology, and Thread technology. For example, the participant edge device 200 may include a Bluetooth-enabled earbud speaker that communicates with the host device 102 via a Bluetooth waveform. In another example, the participant edge device 200 may include a communication device that can receive communication from the host device 102 via the VoIP service.

In embodiments, the coaching signal is initiated by a touch input event, which sends the coaching signal to the participant edge device 200 (e.g., without voice communication). For example, the user interface may include a set of buttons or other input icons with a pitch selection (e.g., fastball, or slider) or a pitch selection code (e.g., one, or two). Upon pressing the button (e.g., a button labeled “fastball”), a recorded message, or a speech-to-text program causes the host device 102 to send the instruction signal to the catcher's earbud, where the word “fastball” is outputted. In another example, the coaching signal may be sent as a text and/or graphical message to a smartwatch or other device worn by the catcher that allows the catcher to visually view the text and/or graphic.

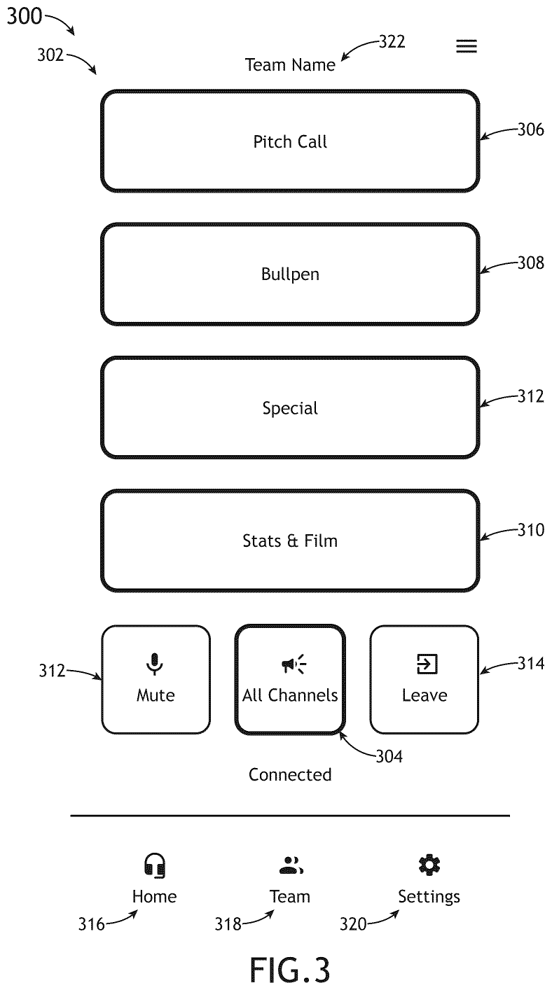

FIG. 3 illustrates a home screen 302 of a user interface 300 for a host device 102, in accordance with one or more embodiments of the disclosure. Similar user interfaces 300 may also be used by the one or more edge devices 106 in communication with the host device. For example, the user interfaces one or more edge devices 106 may include a portion of the selectable aspects (e.g., buttons) of the user interface 300, but not include others, such as an all-channel button 304 that, when pushed on the host device 102, enables the user of the host device 102 to send a voice communication to all edge devices 106 within the set of edge devices. The user interface 300 may include several screens, each screen including different selectable items. It should be understood that the user interface 300 may include one or several different combinations of screens and selectable items within each screen. Therefore, the description herein should not be interpreted as a limitation on the present disclosure, but merely as an illustration.

Referring to FIG. 3, the home screen 302 may further include a pitch call button 306 that, when pressed, causes a pitch call screen to appear. The home screen 302 may further include a bullpen button 308 that, when pressed, causes a bullpen screen to appear to assist with communicating with the bullpen. The home screen 302 may further include an information screen 310 (“stats & film”) button that directs the user to sport statistics and/or film studies. The home screen 302 may include one or more programmable buttons 312 (“special”) allowing the user to add a custom function (e.g., screen or IP link) to the user interface 300. The home screen 302 may further include other buttons, including, but not limited to, buttons for quitting the program (e.g., leave button 314), and muting the host device 102 (e.g., mute button 312). The home screen 302 may also further include a home button 316, a team (e.g., team roster) button 318, a settings button 320, and a team input element 322.

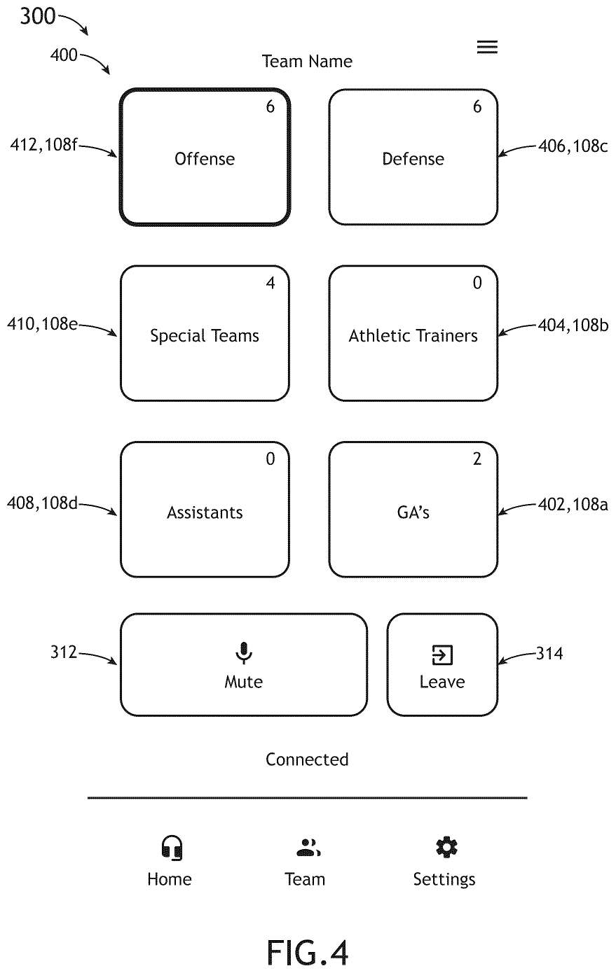

FIG. 4 illustrates a communication screen 400 of the user interface 300 for a host device 102, in accordance with one or more embodiments of the disclosure. For example, the communication screen 400 may be used for communication between groups of football coaches within a team. The communication screen 400 enables the user of the host device 102 to talk to the different coach groups via their edge devices 106. For example, the communication screen 400 displays a graduate assistant (GA) group button 402 associated with a group 108a of the set of edge devices 106. The communication screen 400 may include other buttons including, but not limited to, an athletic trainer button 404, a defense coach button 406, an assistant button 408, a special teams coach button 410, and an offensive coach button 412. All of the different coaching buttons 402, 404, 406, 408, 410, 412 are associated with both a group 108a-f of edge devices 106 and a respective virtual channel 120a-f within the single voice connection 118.

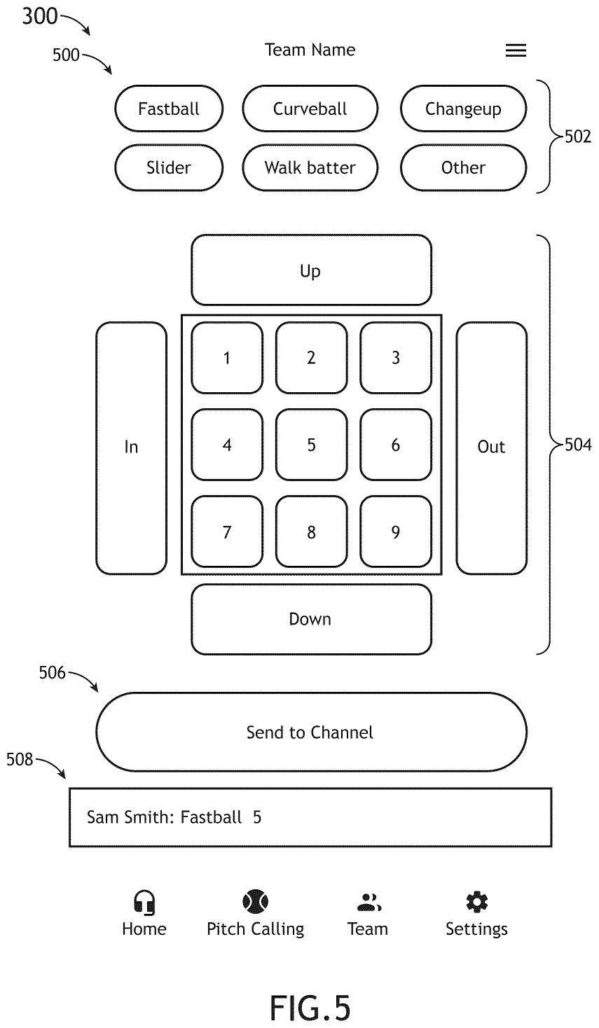

FIG. 5 illustrates a pitch call screen 500 of the user interface 300 for a host device 102, in accordance with one or more embodiments of the disclosure. For example, the pitch call screen 500 may be used by a baseball coach to select a pitch type via pitch selection buttons 502, which sends the coaching instruction (e.g., fastball, curveball, changeup, slider, walk batter, or other) to a catcher. The pitch call screen 500 may also include a target section that 504 allows the coach to instruct where the pitch should be targeted (e.g., to the inside (“in”) or down (“down”). Once the type and or target of the pitch is determined by the coach, the host device 102 can send the coaching instruction (e.g., via the VoIP service and/or the short-range radio communication) once the send-to-channel button 506 is pressed. The pitch call screen 500 may also include a pre-instruction space 508 that indicates to the coach what type/target of pitch was chosen (e.g., a fastball pitch in the middle of the strike zone (zone 5)).

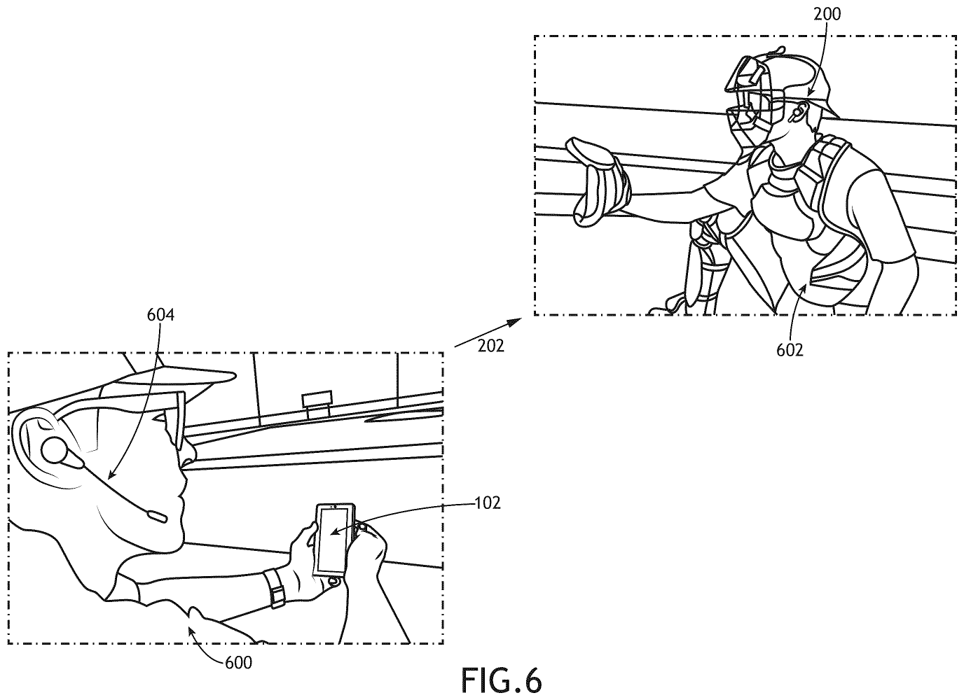

FIG. 6 is an illustration of a system 100 for providing communication between team members in an environment of a baseball event, in accordance with one or more embodiments of the disclosure. For example, during the baseball event (e.g., a baseball practice or game), the coach 600 may use the host device 102 (e.g., a smartphone) to send a coaching instruction in the form of a short-wave communication 202 a participant edge device 200 (e.g., an earbud) worn by a catcher 602 regarding the pitch type and/or pitch target. The catcher 602 then relays the coaching instruction to the pitcher, typically through hand gestures. The coach may further wear a headset 604 that is paired with the smartphone, enabling the coach to talk to one or more groups of team members via one or more groups 108 of edge devices 106.

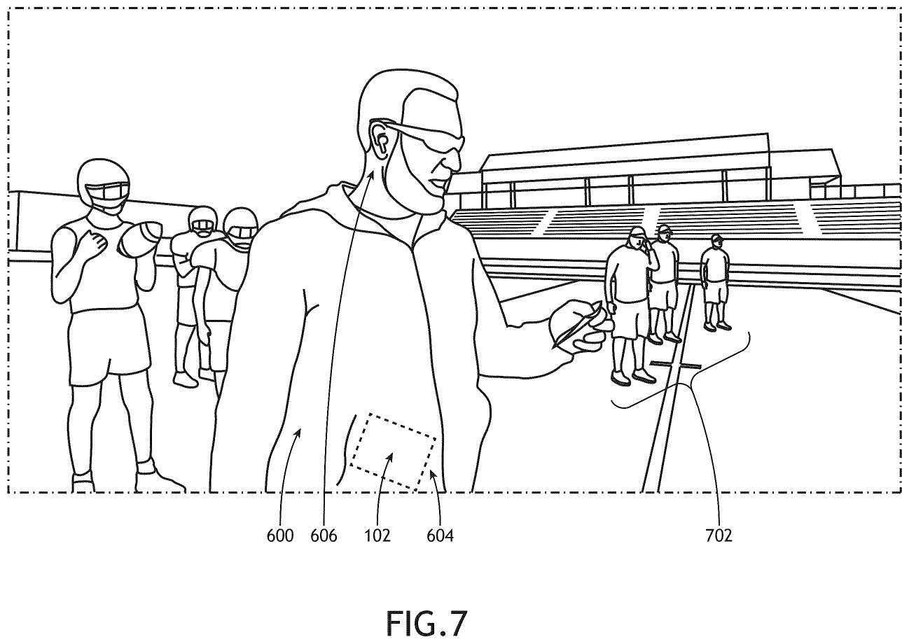

FIG. 7 is an illustration of a system 100 for providing communication between team members in an environment of an American football event, in accordance with one or more embodiments of the disclosure. For example, during the American football event (e.g., a football practice), the coach 600 may use the host device 102 (e.g., a smartphone) to initiate voice communication with a group of assistant coaches 702 after setting up a virtual channel 120a associated with a group 108 of edge devices 106 that are used by the group of assistant coaches 702. Once voice communication has been initiated, the coach 600 can place the host device 102 in a pocket 704 and talk to the group of assistant coaches 702 via an earbud/microphone paired with the host device 102.

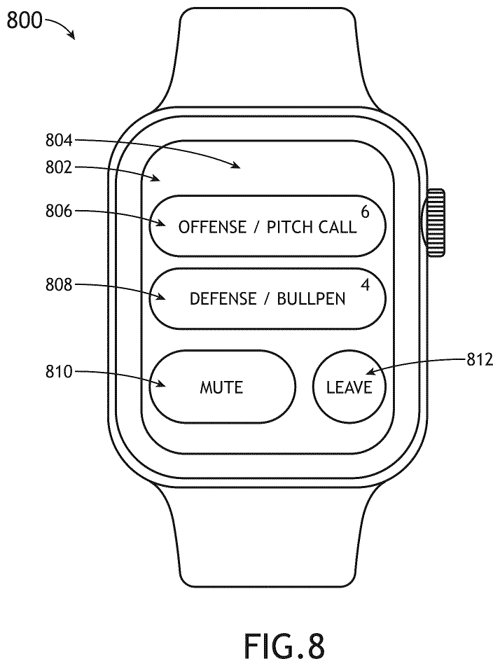

FIG. 8 is an illustration of a top view of a smartwatch 800 used by the system 100, in accordance with one or more embodiments of the disclosure. The smartwatch 800 may act as, or be paired/associated with, the host device 102, the edge device, and/or the participant edge device 200. For example, the smartwatch 800 may be used by a coach 600, with the smartwatch paired with the host device 102. The coach may also pair earbuds 606 with the host device, enabling interconnectivity between the host device 102, the smartwatch 800, and the earbuds 606.

In embodiments, the smartwatch 800 displays a watch user interface 802 that is controlled by software associated with the system 100. The watch user interface 802 may include one or more watch screens 804 that may include one or more buttons similar to the buttons of the user interface 300 of the host device 102. For example, the watch user interface may include an offense or pitch call button 806, a defense or bullpen button 808, a mute button 810 (e.g., for muting a smart watch speaker, the earbuds 606, and/or the host device 102, and a leave button 812.

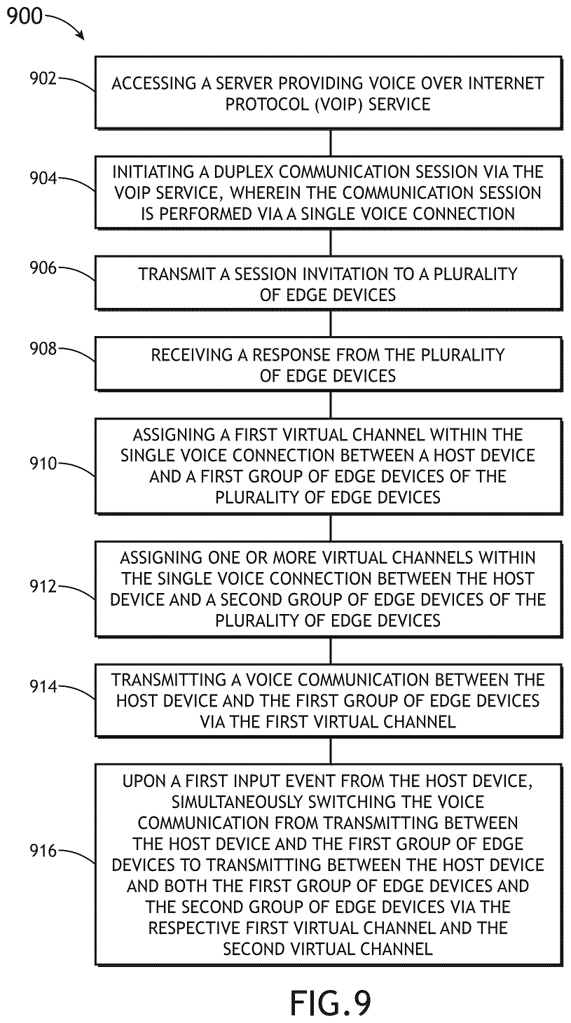

FIG. 9 illustrates a process flow diagram of a method 900 depicting a method for providing audio communication, in accordance with one or more embodiments of the disclosure. The method 900 may be utilized by one or more components of the system 100, including, but not limited to, the host device (e.g., via the one or more processors 112). One or more of the steps of the method 900 may also be utilized by one or more edge devices.

In one or more embodiments, the method 900 includes a step 902 of accessing a server 116 providing voice over internet protocol (VoIP) service. In another embodiment, the method 900 includes a step 904 of initiating a duplex communication session via the VoIP service, wherein the communication session is performed via a single voice connection. In one or more embodiments, the method 900 includes a step 906 of transmitting a session invitation to a plurality of edge devices. In one or more embodiments, the method 900 includes a step 908 of receiving a response from the plurality of edge devices. In one or more embodiments, the method 900 includes a step 910 of assigning a first virtual channel within the single voice connection between a host device and a first group of edge devices of the plurality of edge devices. In one or more embodiments, the method 900 includes a step 912 of assigning one or more virtual channels within the single voice connection between the host device and a second group of edge devices of the plurality of edge devices. In one or more embodiments, the method 900 includes a step 914 of transmitting a voice communication between the host device and the first group of edge devices via the first virtual channel. In one or more embodiments, the method 900 includes a step 916 of, upon a first input event from the host device, simultaneously switching the voice communication from transmitting between the host device and the first group of edge devices to transmitting between the host device and both the first group of edge devices and the second group of edge devices via the respective first virtual channel and the second virtual channel.

In embodiments, the system 100 may be configured to enable an edge device 106 to assume one or more features of the host device 102. For example, when a coach 600 is no longer leading a practice, the coach 600 may designate one or more assistant coaches 702 as a leader for the practice. The system 100 may be configured so that the coach 600 may, via the user interface 300, cause the host device 102 to change the communication profile of one or more edge devices 106 to that of a host device 102 or an interim host device 102, enabling the edge device 106 of the one or more coaches to organize a session, talk with other groups 108 of edge devices 106, or other actions that are typically restricted to that of the host device 102.

In embodiments, the communication profile of an edge device 106 includes an ability of an edge device to communicate with one or more edge devices 106 of the set of edge devices 106. For example, one or more edge devices 106 may be configured with a communication profile that allows one or more edge devices 106 in a group 108 of edge devices to talk to each other. In another example, the one or more edge devices 106 may be configured with a communication profile that allows one or more edge devices 106 to talk to one or more edge devices 106 outside of their group 108.

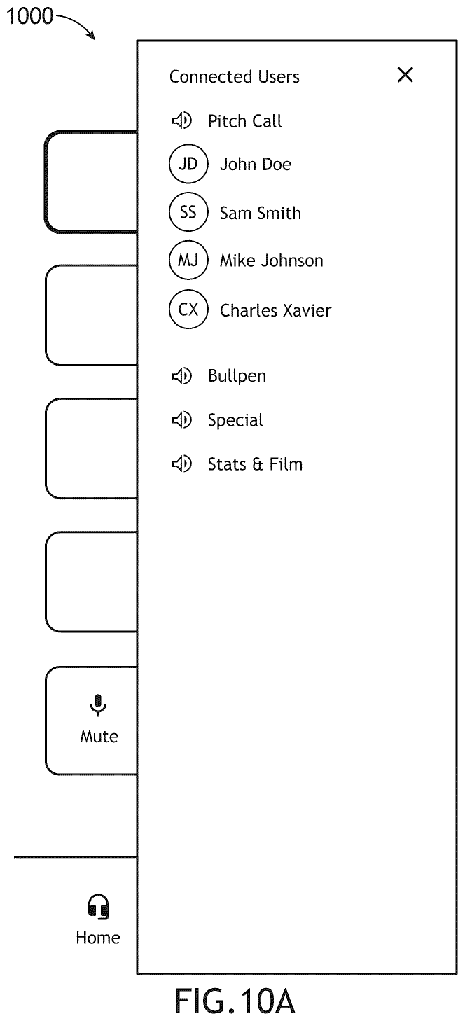

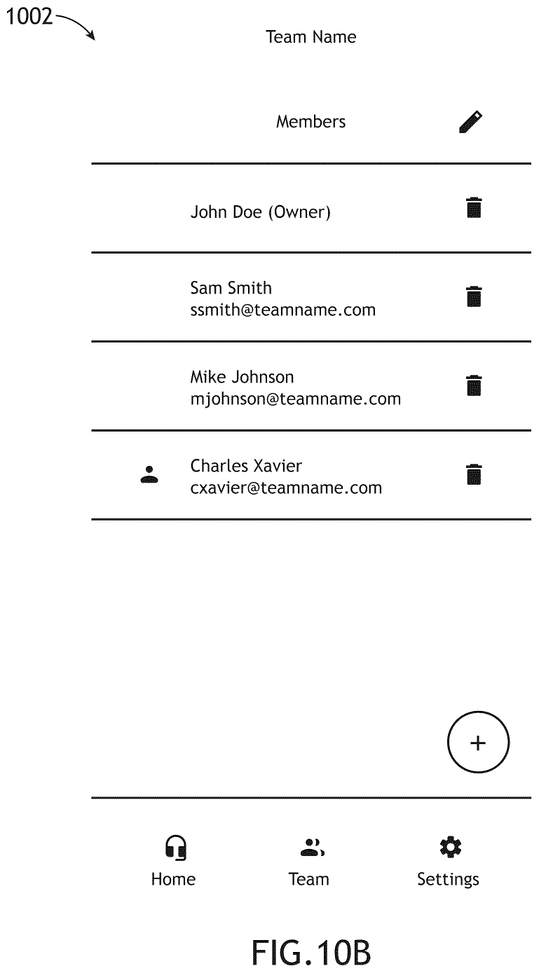

FIGS. 10A and 10B illustrate team-member screens 1000, 1002 of the user interface for a host device, in accordance with one or more embodiments of the disclosure. For example, team-member screen 1000 may include a popup that lists team members. In another example, the team-member screen 1002 is a standalone screen that lists team members.

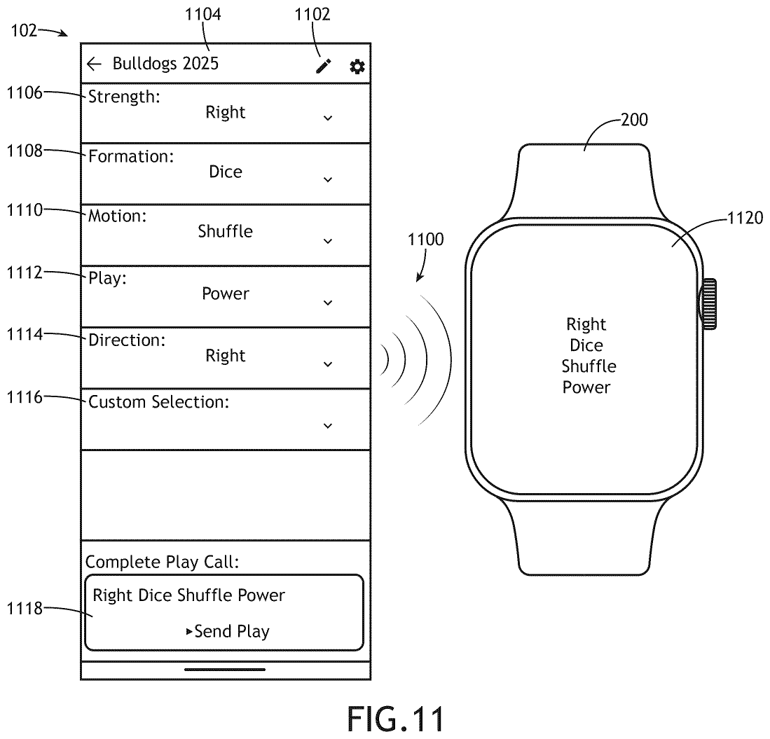

FIG. 11 illustrates a host device 102 transmitting an instruction signal 1100 (e.g., a play call signal) to a participant edge device 200 (e.g., a smartwatch), in accordance with one or more embodiments of the disclosure. A user interface 1102 of the host device 102 displays a screen 1104 that allows the user (e.g., a coach, such as an American football coach) to select a play call based on one or more play characteristics such as strength 1106, formation 1108, motion 1110, play 1112, direction 1114, or other custom characteristic 1116 that are offered from pull-down menus. Once the play call is selected, a send button 1118 is pressed, which sends the play call to the participant edge device 200, where the participant (e.g., an American football team player, such as a quarterback) can then read the displayed play call selection 1120 (e.g., a play call selection instruction).

The one or more processors 112 of the controller 110 may include any one or more processing elements known in the art. In this sense, the one or more processors 112 may include any microprocessor-type device configured to execute software algorithms and/or instructions. In embodiments, the one or more processors 112 may consist of a computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory 114. Moreover, different subsystems of the system 100 may include a processor or logic elements suitable for carrying out at least a portion of the steps described throughout the present disclosure.

The memory 114 may include any memory medium known in the art suitable for storing program instructions executable by the associated one or more processors 112. For example, the memory 114 may include, but is not limited to, a read-only memory, a random-access memory, a magnetic or optical memory device (e.g., disk), a magnetic tape, a solid-state drive and the like. In embodiments, the memory 114 is configured to store one or more results from the system 100 via the various data processing steps described herein. It is further noted that memory 114 may be housed in a common controller housing with the one or more processors 112. In an alternative embodiment, the memory 114 may be located remotely with respect to the physical location of the processors and controller 110. For instance, the one or more processors 112 of the controller 110 may access a remote memory (e.g., server), accessible through a network (e.g., internet, intranet, and the like).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for the sake of clarity.

The herein-described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Although particular embodiments of this invention have been illustrated, it is apparent that various modifications and embodiments of the invention may be made by those skilled in the art without departing from the scope and spirit of the foregoing disclosure. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Accordingly, the scope of the invention should be limited only by the claims appended hereto.

While implementations of the method 900 are discussed herein, it is further contemplated that various steps of the method 900 may be included, excluded, rearranged, and/or implemented in many ways without departing from the essence of the present disclosure. Accordingly, the foregoing embodiments and implementations of the method 900 are included by way of example only and are not intended to limit the present disclosure in any way.

It is further contemplated that each of the embodiments of the method described above may include any other step(s) of any other method(s) described herein. In addition, each of the embodiments of the method described above may be performed by any of the systems described herein.

What is claimed:

1. A system for providing audio communication comprising:
a host device comprising a non-transitory medium with stored instructions that cause the host device to:
access a server providing voice over internet protocol (VoIP) service;
initiate a duplex communication session via the VoIP service, wherein the duplex communication session is performed via a single voice connection;
transmit a session invitation to a plurality of edge devices;
receive a plurality of responses from the plurality of edge devices;
assign a first virtual channel within the single voice connection between a host device and a first group of edge devices of the plurality of edge devices;
assign one or more virtual channels within the single voice connection between the host device and a second group of edge devices of the plurality of edge devices;
transmit a voice communication between the host device and the first group of edge devices via the first virtual channel; and
upon a first input event from the host device, simultaneously switch the voice communication from transmitting between the host device and the first group of edge devices to transmitting between the host device and both the first group of edge devices and the second group of edge devices via the respective first virtual channel and a second virtual channel.

2. The system of claim 1, wherein the first input event comprises a single button input on the host device.

3. The system of claim 1, wherein the stored instructions further cause the host device to, upon a touch input event, transmit a coaching signal to a participant edge device.

4. The system of claim 3, further comprising the participant edge device.

5. The system of claim 3, wherein the coaching signal is transmitted wirelessly to the participant edge device via a short-range radio communication.

6. The system of claim 3, wherein the participant edge device comprises at least one of a watch or a speaker.

7. The system of claim 1, further including the server.

8. The system of claim 1, wherein the stored instructions further cause the host device to assign a communication profile to at least one edge device of the first group of edge devices or the second group of edge devices.

9. The system of claim 8, wherein the communication profile causes the at least one edge device to limit an ability of the at least one edge device to transmit a voice communication.

10. The system of claim 1, wherein the host device comprises one or more processors configured to execute instructions.

11. The system of claim 1, wherein the system provides audio communication between members of a sports team.

12. The system of claim 3, wherein the coaching signal comprises a pitch selection instruction, wherein the pitch selection instruction is received by a baseball catcher wearing the participant edge device.

13. The system of claim 3, wherein the coaching signal comprises a play call selection instruction, wherein the play call selection instruction is received by an American football team player wearing the participant edge device.

14. A non-transitory medium with stored instructions that cause a host device to:
access a server providing voice over internet protocol (VoIP) service;
initiate a duplex communication session via the VoIP service, wherein the duplex communication session is performed via a single voice connection;
transmit a session invitation to a plurality of edge devices;
receive a response from the plurality of edge devices;
assign a first virtual channel within the single voice connection between a host device and a first group of edge devices of the plurality of edge devices;
assign one or more virtual channels within the single voice connection between the host device and a second group of edge devices of the plurality of edge devices;
transmit a voice communication between the host device and the first group of edge devices via the first virtual channel; and
upon a first input event from the host device, simultaneously switch the voice communication from transmitting between the host device and the first group of edge devices to transmitting between the host device and both the first group of edge devices and the second group of edge devices via the respective first virtual channel and a second virtual channel.

15. The non-transitory medium of claim 14, wherein the stored instructions further cause the host device to, upon a second input event, transmit a coaching signal to a participant edge device.

16. The non-transitory medium of claim 15, wherein the coaching signal is transmitted wirelessly to the participant edge device via a short-range radio communication.

17. The non-transitory medium of claim 14, wherein the stored instructions further cause the host device to assign a communication profile to at least one edge device of the first group of edge devices or the second group of edge devices, wherein the communication profile causes the at least one edge device to limit an ability of the at least one edge device to transmit a voice communication.

18. The non-transitory medium of claim 14, wherein the non-transitory medium provides audio communication between members of a sports team.

19. The non-transitory medium of claim 15, wherein the coaching signal comprises a pitch selection instruction, wherein the coaching signal is transmitted to a baseball catcher wearing the participant edge device.

20. A method for providing audio communication comprising:
accessing a server providing voice over internet protocol (VoIP) service;
initiating a duplex communication session via the VoIP service, wherein the duplex communication session is performed via a single voice connection;
transmitting a session invitation to a plurality of edge devices;
receiving a response from the plurality of edge devices;
assigning a first virtual channel within the single voice connection between a host device and a first group of edge devices of the plurality of edge devices;
assigning one or more virtual channels within the single voice connection between the host device and a second group of edge devices of the plurality of edge devices;
transmitting a voice communication between the host device and the first group of edge devices via the first virtual channel; and
upon a first input event from the host device, simultaneously switching the voice communication from transmitting between the host device and the first group of edge devices to transmitting between the host device and both the first group of edge devices and the second group of edge devices via the respective first virtual channel and a second virtual channel.
